(19) United States
(12) Patent Application Publication
(10) Pub. No.: US 2025/0291613 A1
(43) Pub. Date: Sep. 18, 2025

(54) METHOD FOR ASSISTING SELECT OF SCREEN COMPONENTS AND COLLECT OF COORDINATE INFORMATION

(71) Applicant: NETHRU INC., Seoul (KR)

(72) Inventor: Hunsuk RHIM, Seoul (KR)

(21) Appl. No.: 19/223,059

(22) Filed: May 30, 2025

Related U.S. Application Data
(63) Continuation of application No. PCT/KR2024/008067, filed on Jun. 12, 2024.

(30) Foreign Application Priority Data
Jan. 19, 2024 (KR) 10-2024-0009008

(51) Int. Cl. G06F 9/451

(52) U.S. Cl. CPC G06F 9/451

(57) ABSTRACT

A method for assisting in collecting information about screen components performed by a computing device including at least one processor according to some embodiments of the present disclosure is disclosed. The method for assisting in collecting information about the screen components may comprise: determining screen coordinates corresponding to an area within a screen of the computing device on which a pre-designated application is executed, according to a first user interaction of selecting the area; determining User Interface (UI) coordinates within a user interface corresponding to the screen coordinates using a hierarchy structure of parent UI and child UI defined for the application and a translation function corresponding to each of the hierarchy structure; determining a first node corresponding to the UI coordinates; and generating report information for displaying an object representing the first node in a pre-designated visualization format.

### CROSS-REFERENCE TO RELATED APPLICATION

This application is a US Bypass Continuation Application of International Application No. PCT/KR2024/008067, filed on Jun. 12, 2024, which claims priority to and the benefit of Korean Patent Application No. 10-2024-0009008, filed on Jan. 19, 2024, the disclosure of which is incorporated herein by reference in its entirety.

### BACKGROUND

### Technical Field

The present disclosure relates to a method for assisting in collecting information about screen components, and more specifically, to a method for collecting screen components of a computing device located remotely.

### Background Art

The process of distributing apps for the Android operating system can be summarized as follows:

Application Development: First, the app to be executed on the user terminal must be developed. This process may include user interface design, app logic implementation, and testing.

Application Build: Once app development is complete, the app must be built. Building may refer to the process of compiling source code and packaging it into an APK (Android Package) file.

Signing: The app must be signed. Adding a signature to an APK file allows the app to be recognized as coming from a trusted source. Signing may use a debug keystore for development or a release keystore for production.

Google Play Console Registration: To distribute the app on the Google Play Store, it must be registered on the Google Play Console. Through this, app information, pricing, descriptions, screenshots, version management, and more can be configured.

APK Upload: The APK file is uploaded on the Google Play Console. A release APK file can be uploaded, or various release tracks such as Alpha, Beta, and Production can be set.

Resource and Store Page Configuration: Resources such as app icons, graphic materials, descriptions, and the app store page are configured.

Pricing and Country Settings: The app's price is set, and the countries where it will be available are specified. Free or paid apps can be selected, and pricing policies can be managed.

Release and Review: The app is released on the Google Play Console and undergoes Google's review process. The review process verifies the app's content, compliance with advertising policies, and more.

Application Distribution: Once the review is complete, the app is distributed on the Google Play Store. Users can search for and download the app from the store.

Application Update Management: When updating the app or releasing a new version, the previous steps are repeated to upload a new APK file and release it.

User Support and Feedback Management: Interaction with users of the app is managed, and feedback and issue reports are handled to contribute to app improvement.

Marketing and Promotion: After successfully distributing the app, marketing and promotional activities are conducted to attract more users and promote the app.

Natively developed Android applications generally need to follow the above distribution process to reflect the content of the application. Due to the processes of development, build, testing, and distribution, a significant amount of time and resources are consumed, and even when using methods to update the application, the processes of development, build, and testing are still required. Additionally, methods for patching resources remotely cannot change the execution entity, so the changes are limited.

### SUMMARY

The present disclosure has been devised in response to the aforementioned background art and aims to provide a method capable of assisting in collecting information about screen components without requiring rebuilding or redistributing the application.

The technical problems of the present disclosure are not limited to the technical problems mentioned above, and other technical problems not mentioned will be clearly understood by those skilled in the art from the following description.

According to an embodiment of the present disclosure for solving the above-described problems, a method for assisting in collecting information about screen components performed by a computing device including at least one processor is disclosed. The method for assisting in collecting information about the screen components may comprise: determining screen coordinates corresponding to an area within a screen of the computing device on which a pre-designated application is executed, according to a first user interaction of selecting the area; determining User Interface (UI) coordinates within a user interface corresponding to the screen coordinates using a hierarchy structure of parent UI and child UI defined for the application and a translation function corresponding to each of the hierarchy structure; determining a first node corresponding to the UI coordinates; and generating report information for displaying an object representing the first node in a pre-designated visualization format.

In addition, when a second user interaction for translating the user interface displayed on the screen exists for each of the hierarchy structure, the method may further comprise: determining a translation function according to the second user interaction; and the determining the UI coordinates within the user interface corresponding to the screen coordinates may comprise: determining the UI coordinates based on the translation function and the screen coordinates.

In addition, determining the translation function according to the second user interaction may comprise: determining a first matrix value related to a main area included in the user interface; determining a second matrix value related to a scroll area included in the user interface; determining a third matrix value related to the second user interaction; and determining the translation function based on the first matrix value, the second matrix value, and the third matrix value.

In addition, the first node may be a lowermost node located at a lowermost level in the hierarchy, and the translation function may be a function operated for a parent node of the first node.

In addition, the method may further comprise: receiving a third user interaction re-selecting the area; determining a second node corresponding to the UI coordinates other than the first node; and generating report information for displaying an object representing the second node in a pre-designated visualization format.

The technical solutions that can be obtained from the present disclosure are not limited to the solutions mentioned above, and other solutions not mentioned may be clearly understood by those skilled in the art to which the present disclosure pertains from the description below.

The present disclosure aims to provide a method capable of assisting in collecting information about screen components without rebuilding or redistributing the application, according to some embodiments of the present disclosure.

The effects obtainable from the present disclosure are not limited to the effects mentioned above, and other effects not mentioned can be clearly understood by those skilled in the art to which the present disclosure pertains from the description below.

### BRIEF DESCRIPTION OF THE DRAWINGS

Various aspects are now described with reference to the drawings, wherein like reference numerals are used to collectively refer to like components. In the following embodiments, for the purpose of explanation, numerous specific details are presented to provide a comprehensive understanding of one or more aspects. However, it will be apparent that such aspect(s) can be implemented without these specific details. In other instances, well-known structures and devices are shown in block diagram form to facilitate the description of one or more aspects.

FIG. 1 is a block diagram illustrating an example of a computing device according to some embodiments of the present disclosure.

FIG. 2 is a flowchart illustrating an example of a method for generating report information by a computing device according to some embodiments of the present disclosure.

FIG. 3 is a flowchart illustrating an example of a method for determining a translation function according to a second user interaction by a computing device according to some embodiments of the present disclosure.

FIG. 4A is a diagram illustrating an example of a second user interaction according to some embodiments of the present disclosure.

FIG. 4B is another diagram illustrating an example of a second user interaction according to some embodiments of the present disclosure.

FIG. 5 is a diagram illustrating an example of a screen component according to some embodiments of the present disclosure.

### DETAILED DESCRIPTION

The present invention may undergo various modifications and have various embodiments. Specific embodiments are illustrated in the drawings and described in detail in the detailed description. However, this is not intended to limit the invention to specific embodiments, and it should be understood to include all modifications, equivalents, and substitutes that fall within the spirit and scope of the invention. Similar reference numerals are used for similar components while describing each drawing.

The terms first, second, A, B, etc., may be used to describe various components, but the components should not be limited by these terms. These terms are used only for the purpose of distinguishing one component from another. For example, without departing from the scope of the invention, a first component may be referred to as a second component, and similarly, a second component may be referred to as a first component. The term “and/or” includes a combination of a plurality of related listed items or any of the plurality of related listed items.

When a component is said to be “connected to” or “coupled to” another component, it may be directly connected or coupled to the other component, or there may be other components in between. On the other hand, when a component is said to be “directly connected to” or “directly coupled to” another component, it should be understood that there are no other components in between.

The terms used in this application are merely for the purpose of describing specific embodiments and are not intended to limit the invention. Singular expressions include plural expressions unless the context clearly indicates otherwise. In this application, terms such as “comprising” or “having” are intended to specify the presence of features, numbers, steps, operations, components, parts, or combinations thereof described in the specification, and should not be understood to preclude the possibility of the presence or addition of one or more other features, numbers, steps, operations, components, parts, or combinations thereof.

Unless otherwise defined, all terms used herein, including technical and scientific terms, have the same meaning as commonly understood by one of ordinary skill in the art to which this invention belongs. Terms defined in commonly used dictionaries should be interpreted as having meanings consistent with the context of the relevant technology and should not be interpreted in an idealized or overly formal sense unless explicitly defined in this application.

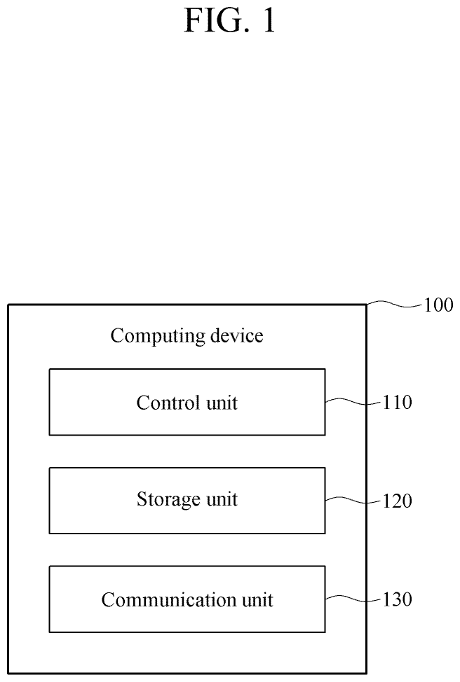

In this disclosure, a computing device may transmit information about screen components to a server. Specifically, the computing device may access a pre-designated library in response to the execution of a pre-designated application. The pre-designated application may be an application pre-distributed to the computing device. The pre-designated application may be an application in which an SDK (Software Development Kit) is installed in the form of a library. The computing device may receive a user interaction selecting an area within the screen of the computing device on which the pre-designated application is executed. The computing device may determine a first node corresponding to the user interaction. Here, the node may be understood as a component constituting the user interface. For example, it can be assumed that an application such as “Integrated Patent Document Editor” exists. Components constituting the user interface of the “Integrated Patent Document Editor” may include an activity class, layout, view group, button, or list. Such activity classes, layouts, view groups, buttons, or lists may be understood as nodes. When the first node is determined, the computing device may generate report information for displaying an object representing the first node in a pre-designated visualization format. The computing device may transmit the report information to a server or the like, thereby causing the server to display the object representing the first node in the pre-designated visualization format. Hereinafter, a method by which the computing device according to this disclosure supports the collection of information about screen components will be described with reference to FIG. 1 to FIG. 5.

FIG. 1 is a block diagram illustrating an example of a computing device according to some embodiments of this disclosure.

Referring to FIG. 1, the computing device 100 may comprise a control unit 110, a storage unit 120, and a communication unit 130. However, the aforementioned components are not essential for implementing the computing device 100, and the computing device 100 may have more or fewer components than those listed above.

The computing device 100 may include any type of computer system or computer device, such as a microprocessor, mainframe computer, digital processor, portable device, or device controller.

The computing device 100 may achieve desired system performance using a combination of typical computer hardware (e.g., devices including computer processors, memory, storage, input devices, and output devices, as well as other components of conventional computing devices; electronic communication devices such as routers and switches; electronic information storage systems such as network-attached storage (NAS) and storage area networks (SAN)) and computer software (i.e., instructions that cause the computing device to function in a specific manner).

The control unit 110 may generally handle the overall operation of the computing device 100. The control unit 110 may process signals, data, information, etc., input or output through the components of the computing device 100 or drive applications stored in the storage unit 120 to provide or process appropriate information or functions for the user.

The control unit 110 may be composed of one or more cores and may include processors for data analysis, such as a central processing unit (CPU), a general-purpose graphics processing unit (GPGPU), or a tensor processing unit (TPU).

In this disclosure, the control unit 110 may determine screen coordinates corresponding to an area within the screen of the computing device 100 according to a first user interaction selecting the area. The control unit 110 may determine User Interface (UI) coordinates within the user interface corresponding to the determined screen coordinates.

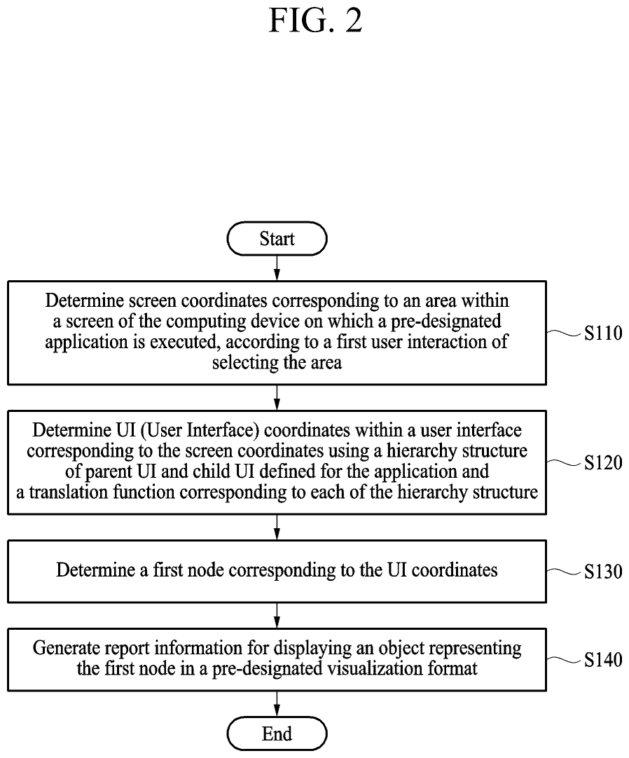

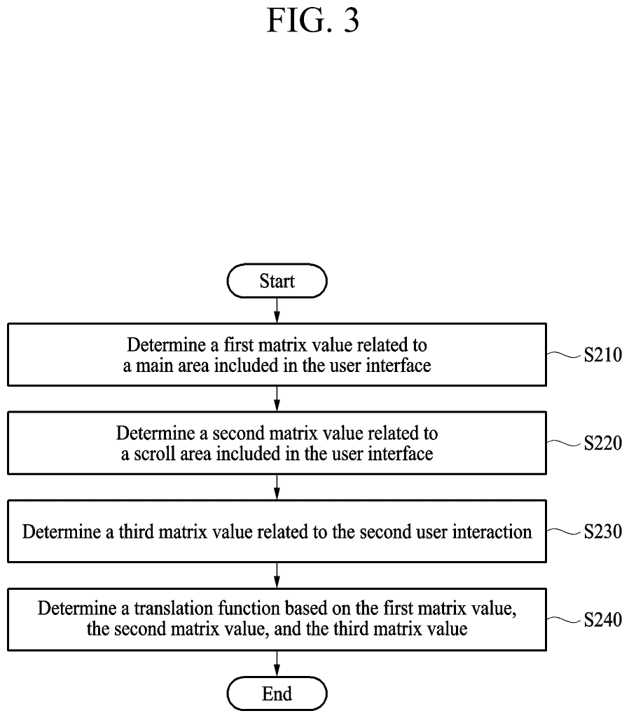

Specifically, the screen coordinates may be coordinates on the display panel of the computing device 100. The display panel of the computing device 100 may have a fixed size as a physical device. Therefore, the screen coordinates may also be determined within a fixed size. On the other hand, the UI coordinates within the user interface may change due to app functions such as scrolling or split screens within the screen. Even if the screen has coordinate values ranging from 1 to 100, the user interface may have coordinate values ranging from 1 to 1,000. Accordingly, even if the user selects the coordinates of point 1,1 on the screen, the UI coordinates may not be 1,1. Therefore, the control unit 110 may determine the UI coordinates within the user interface corresponding to the determined screen coordinates using a function. Hereinafter, an example of a method by which the control unit 110 determines UI coordinates will be described with reference to FIG. 2 and FIG. 3.

The storage unit 120 may comprise a memory and/or a permanent storage medium. The memory may include at least one type of storage medium such as a flash memory type, a hard disk type, a multimedia card micro type, a card-type memory (e.g., SD or XD memory), RAM (Random Access Memory), SRAM (Static Random Access Memory), ROM (Read-Only Memory), EEPROM (Electrically Erasable Programmable Read-Only Memory), PROM (Programmable Read-Only Memory), magnetic memory, magnetic disk, or optical disk.

The communication unit 130 may comprise one or more modules that enable communication between the computing device 100 and a communication system, between the computing device 100 and a server, between the computing device 100 and another computing device, or between the computing device 100 and a network.

Hereinafter, a specific example of a method in which the computing device 100 assists in collecting information about screen components will be described.

FIG. 2 is a flowchart illustrating an example of a method for generating report information by a computing device according to some embodiments of the present disclosure.

Referring to FIG. 2, the control unit 110 of the computing device 100 may determine screen coordinates corresponding to an area within a screen of the computing device 100 on which a pre-designated application is executed, according to a first user interaction of selecting the area (S110). The pre-designated application may be an application pre-distributed to the computing device. The pre-designated application may be an application in which an SDK (Software Development Kit) is installed in the form of a library. The library may be a program compiled to perform only specific partial functions and exist in the form of machine code. The screen coordinates may be coordinates on the display panel of the computing device 100.

The control unit 110 may determine User Interface (UI) coordinates within a user interface corresponding to the screen coordinates using a hierarchy structure of parent UI and child UI defined for the application and a translation function corresponding to each of the hierarchy structure (S120).

The parent UI may be a user interface located at the topmost level in the hierarchy. For example, it may be assumed that an application such as “Integrated Patent Document Editor” exists. The parent UI may be assumed to be an activity class. In this case, the home screen or login screen of the “Integrated Patent Document Editor” application may be the parent UI. Alternatively, the parent UI may be assumed to be a DecorView class. In this case, the parent UI may be the topmost view of the activity. The child UI may be a UI existing in a lower hierarchy under the parent UI. For example, if the parent UI is an activity class, the child UI may include DecorView or LinearLayout.

The translation function may be a function for determining UI coordinates corresponding to the screen coordinates. The translation function may be calculated through the operation of matrix values.

For example, the user interface displayed on the screen may include a main area. The main area may also be understood as a root area. The main area may be an area where movement does not occur even in response to input for moving the user interface. In other words, the main area may be an area where the coordinates do not change according to the scrolling of the screen. The control unit 110 may determine a first matrix value related to the main area. The user interface displayed on the screen may include a scroll area. The scroll area may be an area where movement occurs in response to input for moving the user interface. In other words, the scroll area may be an area where the coordinates change according to the scrolling of the screen. The control unit 110 may determine a second matrix value related to the scroll area. The control unit 110 may determine the translation function based on the first matrix value and the second matrix value. Then, the control unit 110 may determine the UI coordinates based on the determined translation function and the screen coordinates.

The control unit 110 may determine a first node corresponding to the UI coordinates (S130).

The node may be understood as a component constituting the user interface. For example, it may be assumed that an application such as “Integrated Patent Document Editor” exists. Components constituting the user interface of the “Integrated Patent Document Editor” may include an activity class, layout, view group, button, or list. Such activity class, layout, view group, button, or list may be understood as nodes. The control unit 110 may determine a first node corresponding to the UI coordinates.

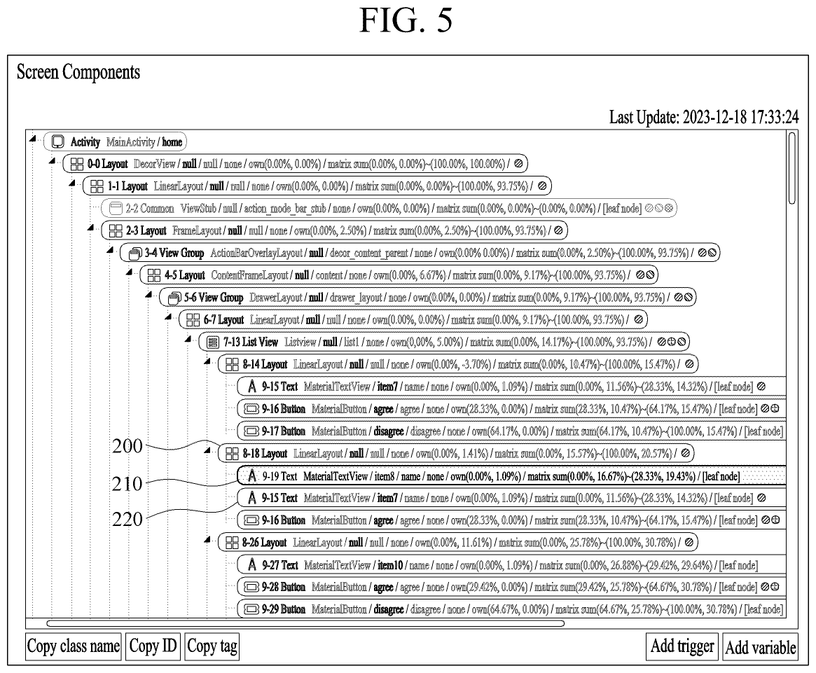

According to one embodiment, the first node may be a lowermost node located at the lowermost level in the hierarchy. Further, the translation function may be a function operated for a parent node of the first node. For convenience of explanation, FIG. 5 may be referred to.

FIG. 5 is a diagram illustrating an example of a screen component according to some embodiments of the present disclosure. The screen in FIG. 5 may be a screen displayed on a server that has received report information, which will be described later.

Referring to FIG. 5, an object 210 representing the first node may be displayed. Referring to the object, it can be confirmed that the first node is the lowermost node located at the lowermost level in the hierarchy.

Specifically, the first node may be a node related to text. There may be no other nodes in the lower hierarchy of the first node. The parent node of the first node may be an activity or activity class located at the topmost level. The control unit 110 may determine the first node corresponding to the UI coordinates by calculating the translation function for the activity.

Referring back to FIG. 2, the control unit 110 may generate report information for displaying an object representing the first node in a pre-designated visualization format (S140). Then, the control unit 110 may transmit the generated report information to a server or another computing device through the communication unit 130. Here, the pre-designated visualization format may be, for example, a format in which the object representing the first node is highlighted. Additionally, the pre-designated format may include a format in which multiple nodes are represented in a tree structure.

According to the above-described configuration, the computing device 100 may determine screen coordinates according to the first user interaction. The computing device 100 may determine UI coordinates corresponding to the screen coordinates. Since the screen coordinates are determined within a fixed size, while the UI coordinates are determined within a flexible size, the computing device 100 may determine the UI coordinates corresponding to the screen coordinates using the translation function. Then, the computing device 100 may generate report information for displaying an object representing the first node corresponding to the determined UI coordinates in a pre-designated visualization format. Accordingly, the user may conveniently check the first node corresponding to the screen coordinates using a server or another computing device that has received the report information.

Meanwhile, according to some embodiments of the present disclosure, a user interaction may include a second user interaction for moving the user interface. Specifically, the user interaction may include a second user interaction for moving the user interface displayed on the screen for each of the hierarchy structure. In this case, the computing device 100 may determine a translation function according to the second user interaction. Then, the computing device may determine the UI coordinates based on the determined translation function and the screen coordinates. Hereinafter, an example of a method in which the computing device 100 determines a translation function according to the second user interaction will be described with reference to FIG. 3.

FIG. 3 is a flowchart illustrating an example of a method for determining a translation function according to a second user interaction by a computing device according to some embodiments of the present disclosure.

Referring to FIG. 3, the controller 110 of the computing device 100 may determine a first matrix value related to a main area included in the user interface (S210).

For example, the user interface displayed on the screen may include a main area. The main area may also be understood as a root area. The main area may be an area where movement does not occur even in response to an input for moving the user interface. In other words, the main area may be an area where coordinates do not change according to the scrolling of the screen. The controller 110 may determine a first matrix value related to the main area. For example, in the case of a mail application, graphic objects representing user interfaces for implementing functions such as deleting, forwarding, and replying to the mail may be arranged within the main area. In this case, the first matrix may be implemented as a matrix that subtracts the size of the main area to define a scroll area to which the translation function is applied within the total screen area of the user terminal. In other words, the first matrix may represent a 1 by 2 matrix determined according to the size of the area occupied by the main area on the screen.

The controller 110 may determine a second matrix value related to a scroll area included in the user interface (S220).

The user interface displayed on the screen may include a scroll area. The scroll area may be an area where movement occurs in response to an input for moving the user interface. In other words, the scroll area may be an area where coordinates change according to the scrolling of the screen. The controller 110 may determine a second matrix value determined according to the size of the area occupied by the scroll area on the screen.

The controller 110 may determine a third matrix value related to the second user interaction (S230).

The second user interaction may be an interaction for moving the user interface. The second user interaction may be an interaction for moving the screen on which the user interface is displayed up, down, left, or right. The controller 110 may determine a third matrix value related to the second user interaction. For example, the controller 110 may determine the third matrix value using the starting point where the second user interaction occurred and the ending point where the second user interaction ended.

The controller 110 may determine a translation function based on the first matrix value, the second matrix value, and the third matrix value (S240). Further, when a first user interaction for selecting an area occurs, the controller 110 may determine UI coordinates within the user interface using the screen coordinates corresponding to the area and the determined translation function.

In other words, when it is determined that the screen displayed within the user interface has changed according to the second user interaction, the controller 110 may determine the translation function so that the changed UI coordinates are reflected.

For example, the screen may have coordinate values ranging from 1 to 100. The user interface may have coordinate values ranging from 1 to 1,000. Before the second user interaction occurs, the screen may display the user interface corresponding to coordinate values ranging from 1 to 100. After the second user interaction occurs, the screen may display the user interface corresponding to coordinate values ranging from 101 to 200. If it is determined that the second user interaction occurred before the first user interaction, the controller 110 may determine the translation function using the second user interaction. Then, based on the occurrence of the first user interaction, the controller 110 may determine the UI coordinates by reflecting the pre-determined translation function, thereby accurately determining the node corresponding to the point selected by the user.

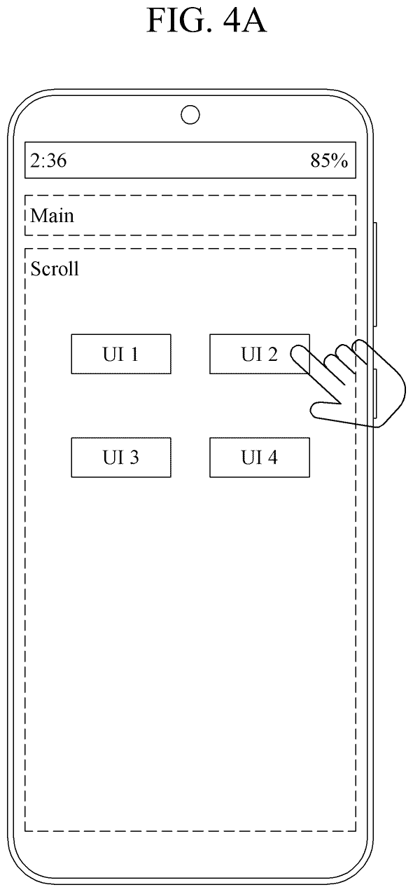

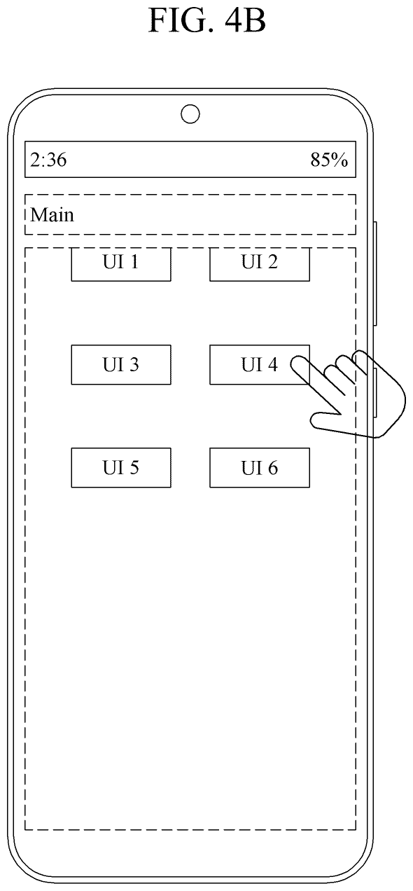

FIG. 4A is a diagram illustrating an example of a second user interaction according to some embodiments of the present disclosure. FIG. 4B is another diagram illustrating an example of a second user interaction according to some embodiments of the present disclosure.

Referring to FIGS. 4A and 4B, the user interface may include a main area and a scroll area. The user may generate a second user interaction for moving the user interface within the scroll area. Alternatively, the user may generate a second user interaction for moving the user interface within both the scroll area and the main area. Even if the second user interaction occurs, the user interface in the main area may not undergo movement or change. In other words, the main area may be an area where coordinates do not change according to the scrolling of the screen.

The scroll area may allow the user interface displayed on the screen to change according to the second interaction. Comparing FIGS. 4A and 4B, the user interface displayed in the scroll area may move upward (or downward). When it is determined that the second user interaction exists, the controller 110 may determine the translation function using the first matrix value related to the main area, the second matrix value related to the scroll area, and the third matrix value related to the second user interaction. Then, when a first user interaction for selecting an area occurs, the controller 110 may determine the UI coordinates within the user interface based on the translation function and the screen coordinates corresponding to the first area.

FIG. 5 is a diagram illustrating an example of a screen component according to some embodiments of the present disclosure.

The screen in FIG. 5 may be a screen displayed on a server that received report information.

Specifically, the controller 110 of the computing device 100 may generate report information for displaying an object representing the first node corresponding to the UI coordinates in a pre-designated visualization format. The controller 110 may transmit the generated report information to a server or another computing device through the communication unit 130. The server that received the report information may display the object 210 representing the first node in a highlighted manner. Accordingly, the user may conveniently check the node selected according to the first user interaction.

Meanwhile, according to some embodiments of the present disclosure, the controller 110 may receive a third user interaction for re-selecting an area. In this case, the controller 110 may determine a second node corresponding to the UI coordinates other than the first node.

For convenience of explanation, FIG. 4B may be referenced. Referring to FIG. 4B, it can be assumed that the user performed a third user interaction to re-select an area. The user may select the UI 4 button through step S110 and then re-select the UI 4 button. On the screen output through the user interface, the UI 4 button is displayed; however, in reality, the UI 4 button may be in a state where multiple other UIs are overlapped. For example, below the UI button, there may exist UI buttons related to text, other buttons, or layouts. Here, “below” can be understood in terms of the Z-axis. For instance, in a screen such as a display panel, assuming the horizontal axis is the X-axis and the vertical axis is the Y-axis, the Z-axis may be an axis generated toward the front and rear of the screen. Such UI buttons may exist in a state where, even if an end user, such as a customer using the application, selects the UI 4 button, there is no particular interaction or the selection is not recognized. However, a user utilizing the computing device 100 according to the present disclosure may need to collect information about the buttons existing below the UI 4 button. Therefore, when a third user interaction for re-selecting an area occurs, the controller 110 may determine a second node corresponding to UI coordinates other than the first node. Then, the controller 110 may generate report information for displaying an object representing the second node in a pre-designated visualization format. For example, referring again to FIG. 5, the controller 110 may generate report information for displaying an object 220 representing the second node existing in the same hierarchy as the first node in a pre-designated visualization format.

According to one embodiment, the controller 110 may determine a third node hierarchically higher than the first node according to a user interaction for re-selecting an area that occurs after the occurrence of the third user interaction. Then, the controller 110 may generate report information for displaying an object 200 representing the third node in a pre-designated visualization format. The controller 110 may also generate report information for displaying an object representing the parent node of the first node in a pre-designated visualization format according to a user interaction for re-selecting an area that occurs after the occurrence of the third user interaction.

According to the above-described configuration, the computing device 100 may determine nodes corresponding to UI coordinates even if they are not output through the user interface. Then, the controller 110 may generate report information for displaying an object representing the determined node in a pre-designated visualization format.

Accordingly, the user may collect information about components that are not output on the screen.

The description of the presented embodiments is provided to enable any person skilled in the art to utilize or implement the present disclosure. Various modifications to these embodiments will be apparent to those skilled in the art, and the general principles defined herein may be applied to other embodiments without departing from the scope of the present disclosure. Thus, the present disclosure is not limited to the embodiments presented herein but is to be accorded the broadest scope consistent with the principles and novel features disclosed herein.

What is claimed is:

1. A method for assisting in collecting information about screen components performed by a computing device including at least one processor, comprising:
determining screen coordinates corresponding to an area within a screen of the computing device on which a pre-designated application is executed, according to a first user interaction of selecting the area;
determining User Interface (UI) coordinates within a user interface corresponding to the screen coordinates using a hierarchy structure of parent UI and child UI defined for an application and a translation function corresponding to each of the hierarchy structure;
determining a first node corresponding to the UI coordinates; and
generating report information for displaying an object representing the first node in a pre-designated visualization format.

2. The method for assisting in collecting information about screen components according to claim 1, further comprising:
determining a translation function according to a second user interaction for translating the user interface displayed on the screen for each of the hierarchy structure, when the second user interaction exists,
wherein the determining the UI coordinates within the user interface corresponding to the screen coordinates comprises:
determining the UI coordinates based on the translation function and the screen coordinates.

3. The method for assisting in collecting information about screen components according to claim 2, wherein determining the translation function according to the second user interaction comprises:
determining a first matrix value related to a main area included in the user interface;
determining a second matrix value related to a scroll area included in the user interface;
determining a third matrix value related to the second user interaction; and
determining the translation function based on the first matrix value, the second matrix value, and the third matrix value.

4. The method for assisting in collecting information about screen components according to claim 2, wherein the first node is a lowermost node located at a lowermost level in the hierarchy, and
the translation function is a function operated for a parent node of the first node.

5. The method for assisting in collecting information about screen components according to claim 1, further comprising:
receiving a third user interaction re-selecting the area;
determining a second node corresponding to the UI coordinates; and
generating report information for displaying an object representing the second node in a pre-designated visualization format.
